(19) United States
(12) Patent Application Publication
(10) Pub. No.: US 2009/0057300 A1
(43) Pub. Date: Mar. 5, 2009

(54) Heating system for plastic processing equipment having a profile gap

(75) Inventors: Bruce F. Taylor, Worthington, OH (US); Arthur C. Weinrich, Cincinnati, OH (US); Robert Kadykowski, New Richmond, OH (US)

Correspondence Address: Roth,Blair,Roberts, Strasfeld & Lodge, 100 Federal Plaza East, Suite 600, YOUNGSTOWN, OH, 44503-1893, US

(73) Assignee: Xaloy Incorporated

(21) Appl. No.: 12/229,200

(22) Filed: Aug. 20, 2008

Related U.S. Application Data
(60) Provisional application No. 60/966,378, filed on Aug. 27, 2007.
(60) Provisional application No. 60/967,220, filed on Aug. 31, 2007.

(51) Int. Cl. H05B 6/10

(52) U.S. Cl. 219/635

(57) ABSTRACT

A system for processing plastic feed material includes a barrel having an upstream feed section and a downstream output section. A screw, supported for rotation in the barrel, cooperates with an inner surface of the barrel to form a path in which the feed material moves toward the output section. A heating system includes an induction winding encircling and extending along a portion of an outer surface of the barrel, and a gap interposed between the induction winding and the barrel and having a nonuniform thickness that varies around the periphery and corresponds to a varying wall thickness of the barrel.

This application claims priority to and the benefit of U.S. Provisional Application No. 60/966,378, filed Aug. 27, 2007, and U.S. Provisional Application No. 60/967,220, filed Aug. 31, 2007, the full disclosures of which are incorporated herein by reference.

### BACKGROUND OF THE INVENTION

1. Field of the Invention

This invention relates generally to the heating of equipment used to process plastic material. More particularly, the invention relates to induction heating a metal barrel of the type used for injection molding and extrusion of plastics.

2. Description of the Prior Art

Solid plastic feed material enters the feed end of a barrel and then is sheared, mixed and metered by a rotating screw, which forces the material in a molten state through a nozzle or a die at the discharge end. To help melt the plastic, band-heaters, arranged on the barrel's outer surface, are heated from an electric power source.

Band-heaters are typically 30 to 70 percent energy efficient, i.e., 70 to 30 percent of the power they consume is lost to ambient in the form of radiation and convection losses. Band-heaters also add thermal mass, i.e. the product of the heating element's mass and effective specific heat, to the system. They must be at a higher temperature than the barrel in order to conduct and radiate heat into the barrel. Consequently, band-heaters add significant thermal inertia to the system, retarding temperature control response.

As the unheated plastic feed material enters the barrel, the temperature of the barrel wall drops in the vicinity of the feed material inlet, resulting in a demand for heat in that zone. Band-heater surface heat losses to ambient are also usually much larger in that zone where they typically operate at a higher power level, and hence are hotter, leading to exponentially higher radiation and convection losses, and lower efficiency.

A need exists in the industry for a technique to overcome thermal inertial, high temperature, delayed response, thermal inefficiency, excessive heat loss to the ambient and other disadvantages of band-heaters.

### SUMMARY OF THE INVENTION

A system for processing plastic feed material includes a barrel having an upstream feed section and a downstream output section. A screw, supported for rotation in the barrel, cooperates with an inner surface of the barrel to form a path in which the feed material moves toward the output section. A heating system includes an induction winding encircling and extending along a portion of an outer surface of the barrel and a gap interposed between the induction winding and the barrel and having a nonuniform thickness that varies around the periphery and corresponds to a varying wall thickness of the barrel. Thermal insulation may be located in the gap. A band heater, located downstream from the induction winding and extending along the outer surface, may be used.

The invention combines an induction heated first barrel temperature zone, with one or more downstream zones, which are heated by insulated or un-insulated band-heaters. Induction heating applies more heat, in a smaller area, more rapidly, than do band-heaters.

Equipping only the first zone with inductor windings and an interposed layer of thermal insulation eliminates a large share of the total heat losses to ambient. The incremental cost increase of the induction heating system is less than the cost benefit of the energy savings provided by it, thereby improving the return on investment deriving from the induction system.

When electric power to the induction windings is turned off, barrel heating ceases immediately; when induction power is turned on, the maximum heating rate is reached instantly. Induction barrel heating, therefore, reduces energy consumption, permits faster heat-up response and enables tighter temperature control during process disturbances.

Induction heating controls the barrel temperature in the first zone better during process disturbances including the cyclical addition of cold material in each machine cycle on injection molding machines, thereby reducing downstream process temperature variability.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

Having generally described the nature of the invention, reference will now be made to the accompanying drawings used to illustrate and describe the preferred embodiments thereof. Further, these and other advantages will become apparent to those skilled in the art from the following detailed description of the embodiments when considered in the light of these drawings in which:

FIG. 1 illustrates an injection molding barrel heated by band-heaters;

FIG. 2 illustrates the same injection molding barrel heated by electromagnetic induction;

FIG. 3 illustrates an injection molding barrel heated by electromagnetic induction in a first zone and by un-insulated band-heaters in other zones;

FIG. 4 is a chart showing heater power consumption achieved with band-heaters in comparison to induction windings on three-zone and four-zone barrel heating applications;

FIG. 5 is a chart showing the resulting energy saving using band-heaters and induction windings on a three-zone barrel heating application of the type described with reference to FIG. 3;

FIG. 6 is a chart showing the resulting power saving using band-heaters in comparison to induction windings on a four-zone barrel heating application of the type described with reference to FIG. 3;

FIG. 7 illustrates an injection molding barrel heated by electromagnetic induction in a first zone and by band-heaters covered with thermal insulation in other zones;

FIG. 8 is an end view of barrel having two bores for twin screws and a non-uniform wall thickness;

FIG. 9 is a schematic diagram of an AC induction heating system for heating a barrel in injection molding and extrusion of plastics;

FIG. 10 is an end view of a barrel having a uniform wall thickness showing an induction winding and thermal insulation encircling the barrel; and

FIG. 11 is an end view of a twin screw barrel having a non-uniform wall thickness showing an induction winding and thermal insulation encircling the barrel.

### DESCRIPTION OF THE PREFERRED EMBODIMENT

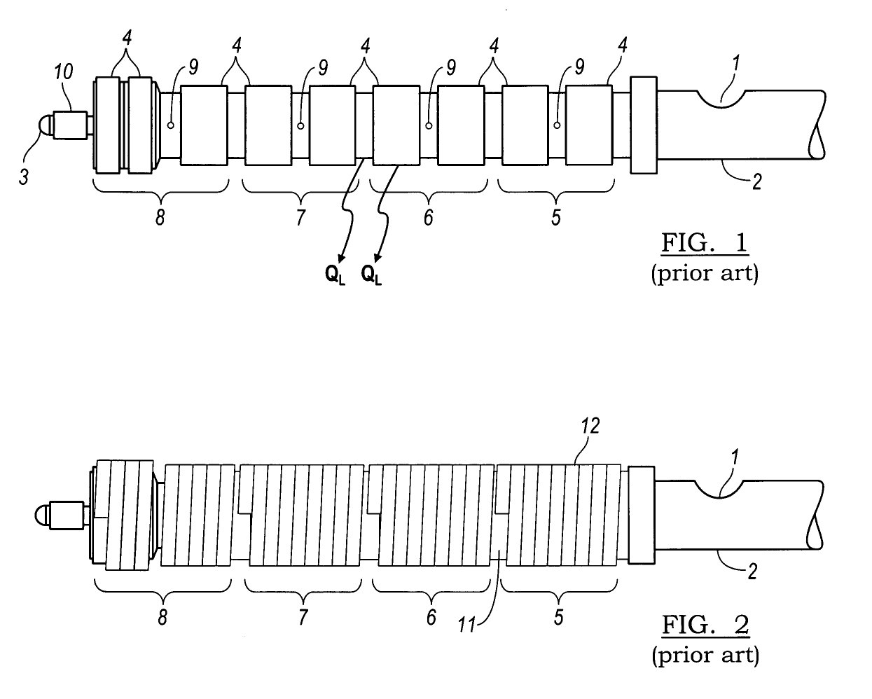

Referring to FIG. 1, solid plastic feed material, typically in the form of pellets or powder, enters the feed end 1 of a barrel 2 for injection molding and extruding plastics. Upon entering the barrel the temperature of the feed material, is low relative to a desired temperature during processing. The feed material then is sheared, mixed and metered by a screw that rotates within the barrel. The resulting molten material is then forced out of the barrel under pressure through a nozzle or die at the discharge end 3 of the barrel 2.

To help melt the plastic, the barrel 2 is also heated with external electric resistance contact heaters 4, commonly referred to as band-heaters. Furthermore, the band-heater electrical circuitry is usually arranged so that the barrel 2 can be heated in multiple controllable zones 5, 6, 7 and, 8 along the barrel's length. Usually three to six heating zones are used, each zone having one thermocouple 9 located in the barrel wall to provide measured temperature feedback. The nozzle or die at the discharge end 3 is heated and temperature controlled separately using one or more dedicated band-heaters 10.

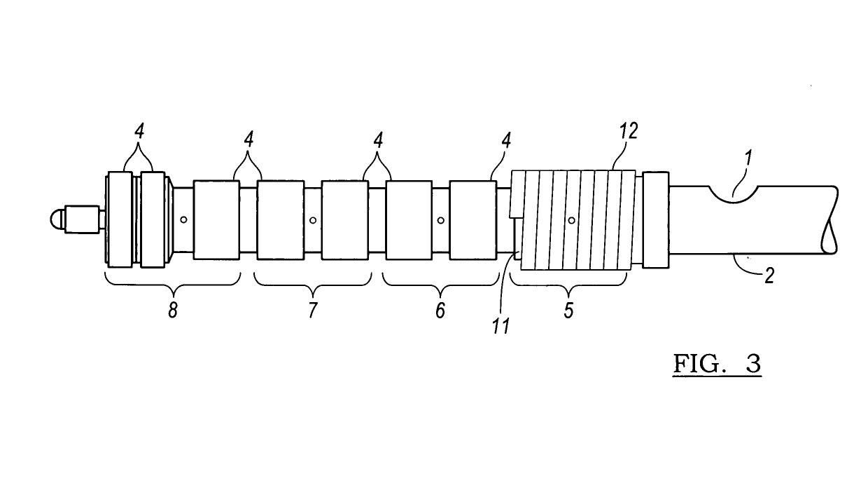

AC induction can be used to heat injection molding and extrusion barrels by inducing eddy currents within the barrel wall to produce direct resistive heating of the barrel 2. Referring now to FIGS. 1 and 2, AC induction barrel heating systems employ a thermal insulating layer 11 interposed between the inductor windings 12 and the outer surface of the barrel 2 to reduce heat loss and protect the windings. The low-resistance windings 12 typically consisting of Litz wire to minimize winding heat generation, keeping the windings efficient. It is important to note that band-heaters 4 add significant thermal inertia to the system, retarding temperature control response, while induction barrel heating reduces energy consumption, shortens heat-up time, and enables tighter temperature control during process disturbances compared to the use of band-heaters.

The importance of the first zone 5 is explained further with reference to FIGS. 1 and 2. When the unheated plastic feed material enters the barrel 2, the barrel wall temperature drops in the first temperature control zone 5 nearest the feed material inlet causing a demand for heat in zone 5. The subsequent heat addition from band-heaters 4 or induction windings 12, combined with viscous heating of the feed material in the barrel (due to friction between the material and the barrel wall, as the screw wipes the material against the wall) supplies the heat needed to melt the material. Additional heat input is then needed primarily to compensate for heat losses “Q_{L}” to ambient from the exposed band-heater and barrel surfaces. Such heat losses occur if the barrel 2 is un-insulated, as is common with band-heaters. Band-heater surface heat losses “Q_{L}” to ambient are also usually much larger in the first zone 5 where they typically operate at a higher power level, and hence are hotter, leading to exponentially higher radiation and convection losses, and therefore much lower efficiency. Accordingly, as illustrated in FIG. 3, equipping the first zone 5 with induction heating equipment consisting of inductor windings 12 and an interposed layer of thermal insulation 11, therefore, eliminates a large portion of the total heat losses to ambient.

Induction heating applies more heat in a smaller area more rapidly than do band-heaters 4, primarily due to the band-heaters' thermal inertia and their operating temperature and reliability constraints. Therefore, induction heating is able to control the barrel temperature better throughout process disturbances, including the cyclical addition of cold material in each machine cycle on injection molding machines, thereby reducing downstream process temperature variability as well.

Referring now to FIG. 3, a preferred embodiment may use induction heating of the first zone 5 followed by heating with un-insulated band-heaters 4 in the downstream zones 6, 7, 8. The resulting hybrid-barrel heating system, which combines both induction and conventional contact resistance heating principles, saves a significant amount of energy, even though only one zone is equipped with efficient induction heating equipment.

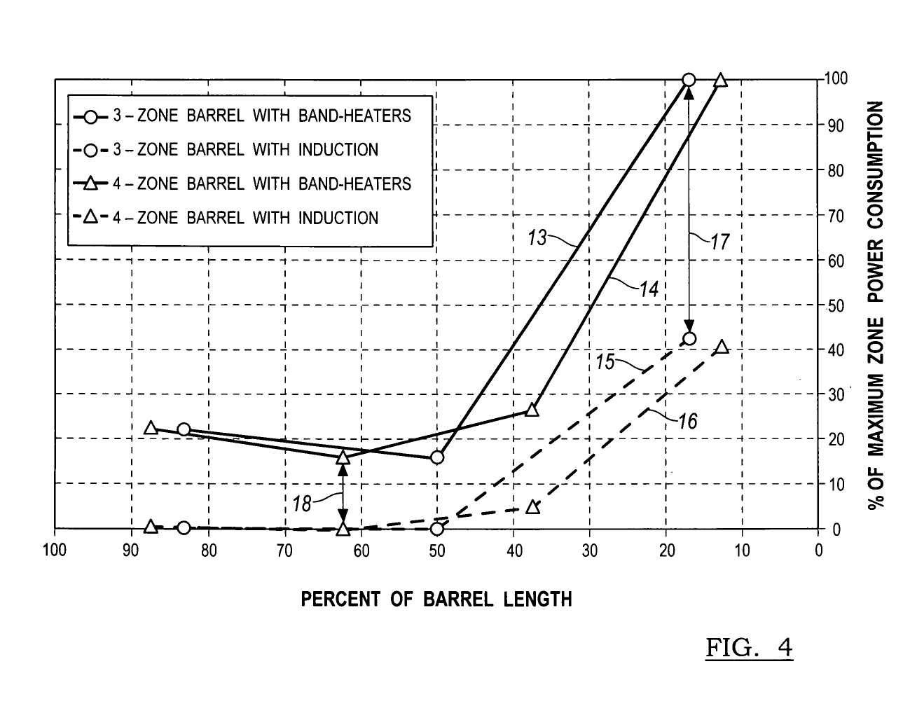

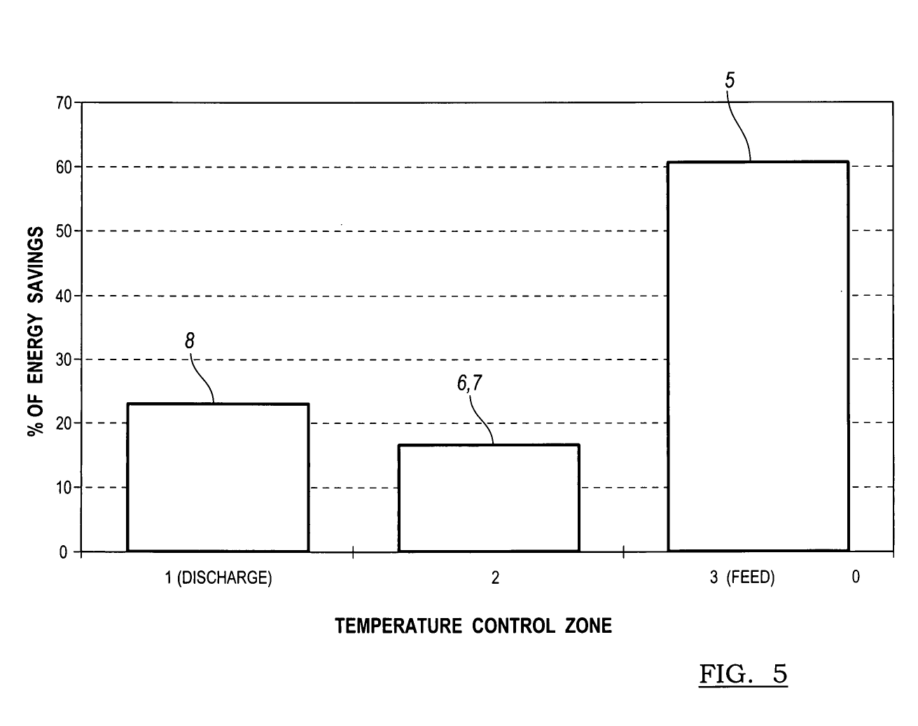

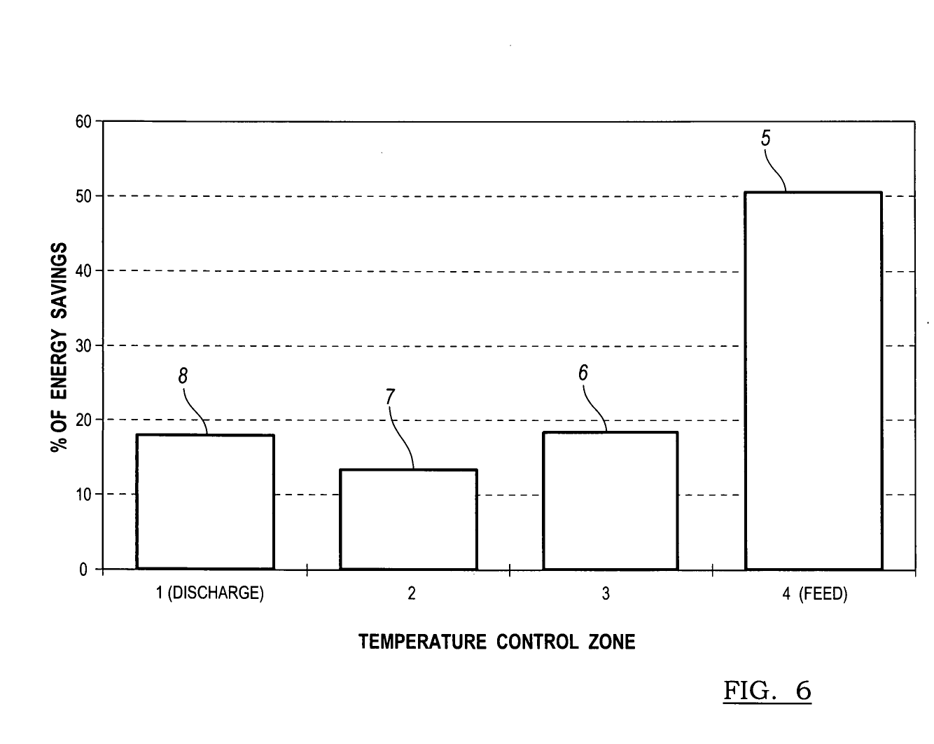

The comparative heating system power consumption curves 13, 14, 15, 16 of FIG. 4 relate to a multiple-zone injection molding barrel 2 with constant processing conditions, i.e., material throughput rate, control zone temperatures, etc. The three zone system includes an upstream heating zone 5 near the feed inlet 1, a downstream discharge zone 8 and a combined intermediate zone at 6, 7, located between zones 5, 8. The four zone system includes an upstream heating zone 5 near the feed inlet 1, a downstream discharge zone 8 and two intermediate zone 6, 7 located between zones 5, 8. The zones were heated by un-insulated band-heaters 4 (as illustrated in FIG. 1), and by insulated electromagnetic induction windings 12 (as illustrated in FIG. 2). The respective relative energy savings 17, 18 in each zone, achieved by eliminating the heat loss “Q_{L}” to ambient in each zone, shown in FIG. 4, is computed and plotted in FIGS. 5 and 6.

The graphical results illustrated in FIGS. 5 and 6 indicate that replacing un-insulated band-heaters 4 with inductor windings 12 in only the first zone 5 delivers 50-60% of the energy savings that could be achieved if the entire length of the injection molding barrel 2 were equipped with induction heating windings 12, which would cost three to four times more than equipping just the first zone 5 with induction windings. The hybrid configuration illustrated in FIG. 3 reduces the initial induction equipment cost by about 66-75% for three-zone and four-zone systems, respectively, while only reducing the savings by about 40-50% for three-zone and four-zone systems, respectively. A reduction in the investment payback period of 45-50% results (i.e. 50%=(1−0.75)/(1−0.5)).

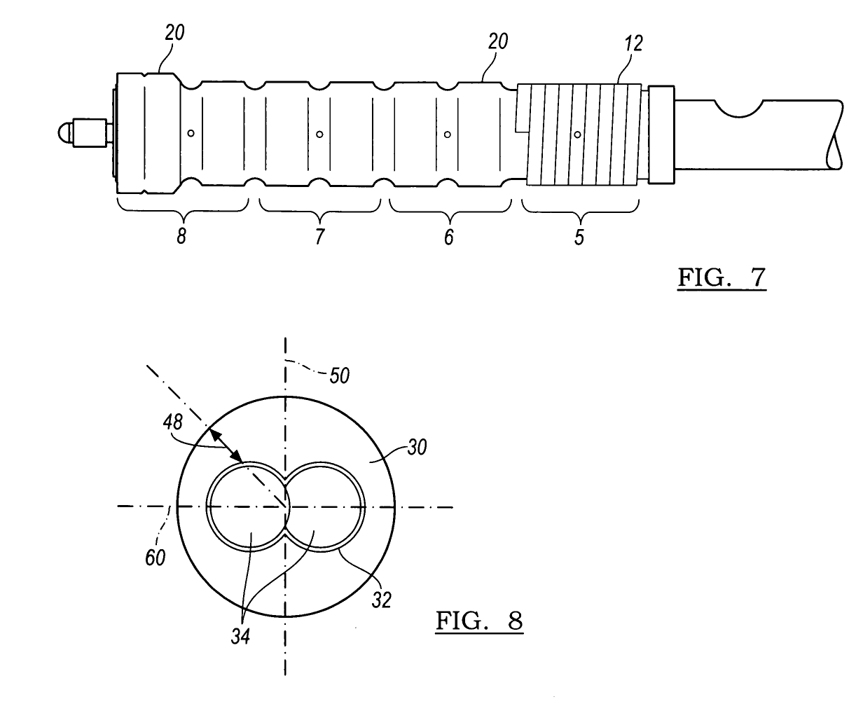

In the embodiment illustrated in FIG. 7, induction heating is employed in zone 5, but the downstream zones 6, 7, 8 are heated with band-heaters 4. External thermal insulation 20 covers the band-heaters 4 and the outer surface of the barrel 2 in zones 6, 7, 8 to eliminate heat losses to ambient from exposed band-heater and barrel surfaces, so that even more energy savings can be achieved with minimal additional investment, i.e., only the cost of the added insulation 20.

The twin screw extruder barrel 30 shown in FIG. 8 has an irregular internal bore 32, within which rotates two extruder screws 34. Solid plastic feed material, typically in the form of pellets or powder, enters the feed end of the barrel and then is sheared, mixed and metered by the screws' rotation. The feed material becomes molten and is then forced out under pressure through a die at the discharge end of the barrel 30. To help melt the plastic feed material, the barrel 30 is also heated by external resistive contact heaters, band-heaters 4, or by induction windings 12.

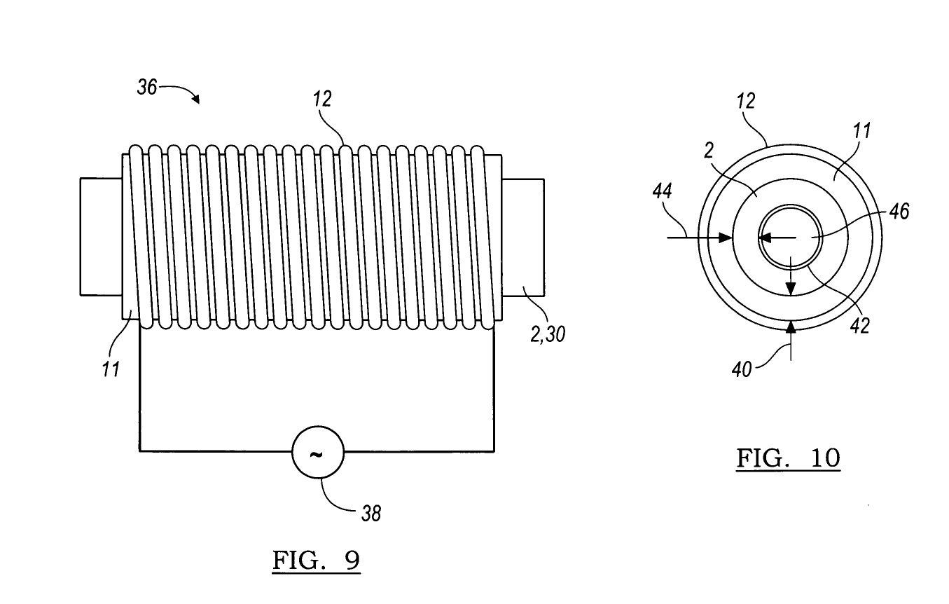

Referring now to FIG. 9, an AC induction heating system 36 includes a helical tunnel-coil formed by inductor windings 12, which surround one of the barrels 2, 30; a layer of thermal insulation 11, interposed between the windings 12 and the outer surface of the barrel; and a high-frequency (typically 10-30 kHz) induction power supply 38 used to heat the barrel by inducing eddy currents within the barrel wall to produce direct resistive heating of the barrel.

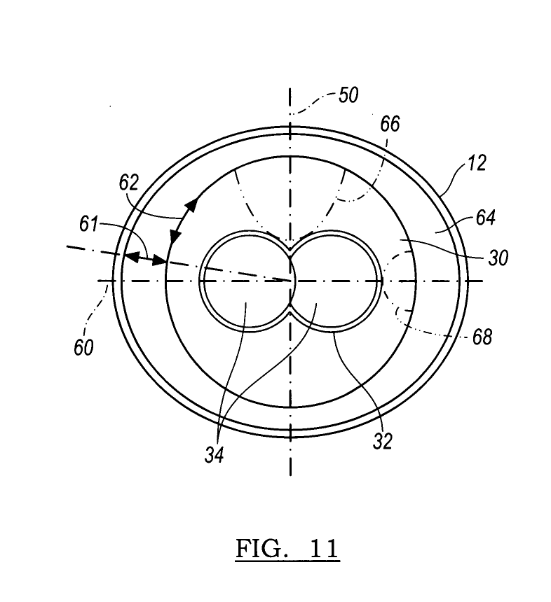

FIG. 10 shows that the thermal insulating layer 11 has a uniform wall thickness, which establishes a uniform insulation thickness or gap 40 between the helical inductor windings 12 and the barrel 2. The barrel 2 has a round bore 42, uniform wall thickness 44, and contains a single screw 46. Due to the uniform circumferential gap 40, the barrel is uniformly heated by a uniform number of watts per angular increment of the barrel's circumference. Uniform heating is desirable given the uniform wall thickness 44 and symmetry of the barrel 2.

On the other hand, the twin-screw barrel 30 of FIGS. 8 and 11 has a non-uniform wall thickness 48, which is substantially thicker along axis 50 and substantially thinner along axis 60. Consequently, to produce a uniform temperature increase per unit of time around the circumference of a twin-screw barrel 30, the heat input rate should not be uniform, but should be higher near axis 50 and lower near axis 60.

The rate “q” at which a load is heated is inversely and exponentially proportional to the thickness of the gap “g” 40, 61 between the inductor and load, i.e. q=fn(1/g²).

As FIG. 11 illustrates, this gap sensitivity is used definitively to vary or profile the heating rate around the circumference or periphery 62 of a cylindrical element, such as the twin-screw extruder barrel 30, by interposing a thermal insulation layer 64 having a non-uniform or profiled thickness, i.e. profiled gap 61, between the inductor windings 12 and the heated cylindrical element or barrel 30. Notably, gaps 40, 61 may be void and contain no thermal insulation. For a given total amount of heat supplied to the barrel 30 per unit length, substantially more heat will be generated within the barrel wall in the region 66 near axis 50, while substantially less heat will be generated within the barrel wall in the region 68 near axis 60. This distribution of heat produces a more uniform temperature for each increment of the barrel's circumference than if the heat were uniformly distributed around the circumference.

It should be noted that the present invention can be practiced otherwise than as specifically illustrated and described, without departing from its spirit or scope. It is intended that all such modifications and alterations be included insofar as they are consistent with the objectives and spirit of the invention.

What is claimed is:

1. A system for processing plastic feed material comprising:
a barrel including an upstream feed section and a downstream output section;
a screw supported for rotation in the barrel, the screw and an inner surface of the barrel forming a path in which the feed material moves toward the output section; and
a heating mechanism including an induction winding encircling and extending along a portion of an outer surface of the barrel, and a gap located between the induction winding and the barrel and having a non-uniform thickness that varies around a first periphery of the barrel and corresponds to a varying wall thickness of the barrel.

2. The system of claim 1 further comprising a first thermal insulation at least partially filling the non-uniform thickness of the gap between the induction winding and the barrel.

3. The system of claim 2 further comprising a second thermal insulation having a uniform thickness around a second periphery of the barrel.

4. The system of claim 3 wherein the heating mechanism further comprises:
a band heater extending along the outer surface and located downstream from the induction winding; and
a third thermal insulation that covers the band heater.

5. The system of claim 1 wherein a length of the barrel is divided into heating zones comprising:
an upstream zone containing the induction winding and a first thermal insulation at least partially filling the non-uniform thickness of the gap between the induction winding and the barrel; and
a downstream zone located downstream of the upstream zone and containing a band heater.

6. The system of claim 5 wherein the heating mechanism further comprising a third thermal insulation that covers the band heater.

7. The system of claim 5 wherein the heating mechanism further comprising a source of AC electric power electrically connected to the induction winding and the band heater.

8. A system for processing plastic feed material comprising:
a barrel including an upstream feed section, a downstream output section, a wall including an outer surface and a thickness that varies around a periphery of the barrel, and passageways that extends along a length of the barrel for containing feed material moving away from the feed section toward the output section;
an induction winding encircling the outer surface and extending along at least a portion of a length of the barrel; and
a first thermal insulation interposed between the induction winding and the outer surface, the first thermal insulation having a thickness that varies around a periphery of the barrel wherein the wall thickness at a first peripheral location is greater than the wall thickness at a second peripheral location, and the thickness of the first thermal insulation at the first peripheral location is less than the thickness of the first thermal insulation at the second peripheral location.

9. The system of claim 8 further comprising:
a band heater located downstream of the induction winding; and
a second thermal insulation that covers the band heater.

10. The system of claim 8 wherein the length of the barrel is divided into zones comprising:
an upstream zone containing the induction winding and the first thermal insulation; and
a downstream zone located downstream of the upstream zone and containing a band heater.

11. The system of claim 9 wherein the length of the barrel is divided into zones comprising:
an upstream zone containing the induction winding and the first thermal insulation; and
a downstream zone located downstream of the upstream zone and containing the band heater.

12. The system of claim 10 further comprising a source of AC electric power electrically connected to the induction winding and the band heater.

13. A system for processing plastic feed material comprising:
a barrel including an upstream feed section, a downstream output section, a wall including an outer surface and a passageway extending along a length of the barrel in which feed material moves from the feed section toward the output section, the wall having a nonuniform thickness that varies around a periphery of the barrel;
an induction winding encircling the outer surface and extending along at least a portion of the length of the barrel; and
a first thermal insulation interposed between the induction winding and the outer surface of the wall, the first thermal insulation having a thickness that varies around the periphery of the barrel and corresponds to the wall thickness of the barrel.

14. The system of claim 13 further comprising:
a band heater located downstream of the induction winding; and
a second thermal insulation that covers the band heater.

15. The system of claim 13 wherein the length of the barrel is divided into heating zones comprising:
an upstream zone containing the induction winding and the first thermal insulation; and
a downstream zone located downstream of the upstream zone and containing a band heater.

16. The system of claim 15 further comprising a source of AC electric power electrically connected to the induction winding and the band heater.

17. The system of claim 16 further comprising a second thermal insulation that covers the band heater.

18. The system of claim 17 wherein the second thermal insulation has a uniform thickness around the periphery of the barrel.
